(19) United States
(12) Patent Application Publication
(10) Pub. No.: US 2002/0041587 A1
(43) Pub. Date: Apr. 11, 2002

(54) Method and device for carrying out simplex data transmission

(76) Inventors: Thomas Reisinger, Regensburg (DE); Christian Schneider, Lappersdorf (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/994,197

(22) Filed: Nov. 26, 2001

Related U.S. Application Data
(63) Continuation of application No. PCT/DE00/01660, filed on May 24, 2000.

(30) Foreign Application Priority Data
May 26, 1999 (DE) 199 24 017.5

(51) Int. Cl. H04B 7/216

(52) U.S. Cl. 370/342; 370/344; 370/479; 370/482; 375/140

(57) ABSTRACT

Method for carrying out simplex transmission of a data message modulated onto a carrier frequency, in particular for simplex radio transmission in a radio access control system, in which the data message is transmitted to increase immunity to interference, whereby the multiple transmission is carried out using at least two different carrier frequencies.

### CROSS-REFERENCE TO RELATED APPLICATION

This application is a continuation of copending International Application No. PCT/DE00/01660, filed May 24, 2000, which designated the United States.

### BACKGROUND OF THE INVENTION

### Field of the Invention

The invention relates to a method for carrying out simplex data transmission of a data message modulated onto a carrier frequency, in particular, for simplex radio transmission in a radio access control system, and a device to carry out the method.

In recent years, electronic access control systems have undergone a surprisingly rapid and widespread distribution in various areas. The functionality of such systems is being continuously extended and, concurrently therewith, the requirements for immunity to interference of the transmission have increased. Thus, in the automotive industry, conventional radio-controlled locking systems, which initially had the importance of a convenience function only (regarded by many car drivers as superfluous), have since become complex systems, through which not only is access gained to the interior of the vehicle, but through which vehicle functions are also controlled. In modern systems, the transfer of an access code via radio carries out user authentication. For the future, it is proposed to transmit user-specific data, which are required in order to control specific functions, along with the access code. Even taking into account a resulting increase in the scope of the corresponding data messages and the time limits imposed by the specifications of the automobile manufacturers on the total transmission process, the bit rates are relatively low, and simple modulation methods (e.g., OOK=On-Off Keying or FSK=Frequency Shift Keying) and of course, for reasons of cost and space, the simplest possible transmitter and receiver structures are used.

Along with automotive systems, building engineering systems represent a further main focal point for the use of radio access control systems. In addition to garage door controls, which have been in use for some time, access control systems in company offices and public buildings are being increasingly used.

A fundamental problem in the further distribution of radio access control systems is that the frequency band in which these systems have to operate (in Europe the ISM band from 433.05 to 434.79 MHz) is used not only by the rapidly increasing number of such systems, but also by intruder alarm systems, telemetry paths, medical equipment, radio remote controls for model cars, radio telephony links, and crane controls. In individual countries, further users must also be considered, e.g., repeater stations in the United Kingdom. In such a context, it must be borne in mind that radio access control systems, in view of the short required range and in the interest of long battery life, operate with very low transmission powers in the μW range. In view of these circumstances, it is not surprising that interference, and, under unfavorable conditions, even total outage, occur with increasing frequency in radio access control systems.

One way of increasing reliability is to provide redundant transmission paths that operate in a different manner, e.g., an infrared path. However, additional transmitters and receivers that are based on totally different principles and that cannot, therefore, be integrated in any way into the main system are required for such a purpose. As a result, there is an increase in the cost outlay and also in the space requirement. The use of more elaborate coding methods and the use of specific narrowband transmission paths normally result in a substantial increase in cost. The use, for example, of error correction mechanisms existing in mobile radiotelephony, which are based on the artificial addition of redundancy to the data message to increase transmission reliability, similarly incurs relatively high hardware and software cost and, similarly, for reasons of cost, is, therefore, unsuitable for low-cost radio access control systems of the type required by the automotive industry.

The similarly conventional measure of multiple transmission of the message on the same carrier, based on the hope that no interference will occur throughout the entire transmission, in many cases does not result in the required success, particularly if the access control system has to be operated in the vicinity of a continuously operating narrowband interference source.

In a prior art method for carrying out simplex data transmission disclosed in German Published, Non-Prosecuted Patent Application DE 196 10 116 A1, a data message is modulated onto two different carrier frequencies and transmitted simultaneously in two different transmission channels. In the receiver, the data messages from the two transmission channels are combined into one single data message.

In an unpublished further method for carrying out simplex data transmission disclosed in International PCT document WO 00/20712 A1, a data message is modulated onto a plurality of carrier frequencies and is transmitted simultaneously or in temporal succession in a plurality of transmission channels. In the receiver, the transmission channel and its data message in which the lowest signal-to-noise ratio is present are selected.

### SUMMARY OF THE INVENTION

It is accordingly an object of the invention to provide a method and device for carrying out simplex data transmission that overcomes the hereinafore-mentioned disadvantages of the heretofore-known devices and methods of this general type and that achieves a clear increase in reliability without a substantial increase in cost.

With the foregoing and other objects in view, there is provided, in accordance with the invention, a method for carrying out simplex transmission of a data message modulated onto a carrier frequency, including the steps of transmitting a data message more than one time using at least two different carrier frequencies in temporal succession to increase immunity to interference, and only changing the carrier frequencies such that the frequencies occur within one single transmission channel. Preferably, the method carries out simplex radio transmission in a radio access control system.

The invention applies, in accordance with another mode of the invention, the fundamental concept of performing a multiple transmission of a data message that is to be transferred on at least two different carrier frequencies. The use of a different carrier frequency for each of the transmissions is particularly efficient.

The proposed measure is surprisingly advantageous, particularly in the case of low-cost radio access control systems for motor vehicles because such systems already use low-cost components with high tolerances (for example, crystals and surface wave filters) and, thus,—due to cost rather than for technical reasons—have a relatively broadband configuration. Small deliberate changes to the carrier frequency can, therefore, easily be made in such systems with no significant effect on the transmission parameters, or can easily be incorporated in the construction of such systems with no substantial impact on cost.

The proposed method, which is referred to below as the Frequency Offset Re-Transmission (“FORT”) method, generally offers advantages, even in its commonest form, if the receiver reveals a performance dependency on the carrier frequency or the carrier frequency/interference frequency ratio, which can be derived even from statistical analysis, i.e., if the existence of an interference source is to be assumed beyond the possible transmission duration, the source, of course, has a specific, more or less broad interference frequency spectrum, and the probability of a reduction in the interference rises with an increase in the effective increase in bandwidth of the user data signal transmission—achieved through multiple transmission at different frequencies.

Due to the tolerances, low-cost systems must have a more broadband construction than is actually necessary. As such, the receiver is able to process not only signals at the nominal carrier frequency, but also signals with slightly deviating carrier frequencies (typically +/−300 ppm) (→receiver bandwidth).

The purpose of the change in the carrier frequency is to change the effect of the interference on the receiver, rather than to eliminate (narrowband) interference as in the case of multi-channel systems. To accomplish the change, the receiver performance must show a dependency on the carrier frequency/interference frequency ratio.

Such a dependency may be more or less significant in different receiver configurations or implementations. If the carrier frequency/interference frequency ratio within the permitted receiver bandwidth has a significant effect on performance, in particular, if minor frequency changes produce substantial changes, the method according to the invention can be advantageously used. If, on the other hand, hardly any dependency can be identified, the method brings no improvements, but does not cause any disadvantages. Accordingly, the method can be used ubiquitously without disadvantageous effects (apart from a minimal increase in implementation cost).

Thus, the improvement achieved by the method according to the invention includes a statistically verifiable higher rate of successful message transmissions.

In accordance with a further mode of the invention, the method is particularly advantageous in respect of narrowband interference in conjunction with the use of spread spectrum technology, in particular, in Direct Sequence Spread Spectrum (“DSSS”) transmission.

From simulation calculations and general system observations, it can be inferred that a frequency deviation between the different carrier frequencies used in a multiple transmission in the order of magnitude of the data rate, in particular, ranging from one quarter to two times the data rate, can be regarded as appropriate. Such differences are tolerated by the systems concerned without significant parameter modifications, and are adequate for a multiplicity of typical interference situations.

FIG. 2 graphically illustrates a special transmission function of a spread sequence. As is immediately evident from the existence of distinct maxima and minima on the curve, the transmission function acts on narrowband interference sources as a filter that either attenuates (minimum) or, in the unfavorable case, amplifies (maximum) the interference source. The gain that can essentially be achieved with the DSSS transmission is, therefore, depending on the position of the interference source, either increased or reduced, which, of course, has a direct effect on the signal-to-noise ratio and, therefore, the bit error rate.

If the transmission frequency is slightly modified with each new transmission of a data message, the carrier frequency control/synchronization circuit at the receiving end is also set to the modified frequency with the conversion of the receive signal into the baseband. However, because the interference signal—according to a practical assumption—does not change its frequency, it is “mapped” onto a different frequency with each new transmission by the conversion into the baseband. Because the transmission function of the spread sequence does not take effect until synchronization has taken place in the baseband, a different signal-to-noise ratio is produced for each transmission. Again, statistical evidence indicates that, in the case of a plurality of transmissions, at least one has taken place in which a higher signal-to-noise ratio has been achieved than in the first transmission—and, therefore, in a conventional transmission without carrier frequency detuning.

As a result, in one variant of the invention with a receiver acknowledgement function, the transmission is carried out at different carrier frequencies until a data message with no bit errors is received at the receiving end. The multiple transmission could then be interrupted, which can help to reduce the response time of the access control system, which (as already explained above) is one of the most critical parameters for practical use. (In the case of simplex transmission, it is not possible to determine whether or not a message has been received without errors.)

In a further configuration of the invention, which can be used depending on the specific response of a synchronization circuit that is used, once synchronization has been achieved, an improvement in the effectiveness of the response is achieved by an additional, controlled frequency detuning that takes place without loss of synchronization, in cases where synchronization performance and bit error performance (determined by the specific transmission function of the spread sequence) are intended to have a compensating effect.

The amount of the carrier frequency change does not need to be very precisely defined because its effect (as explained above) is statistically determined. Tolerances in the ±10% range can be regarded as permitted, and imply a substantial advantage for implementation in low-cost systems. The tolerance range can be within ±1% to 10%.

With the objects of the invention in view, there is also provided a device for carrying out simplex transmission of a data message modulated onto a carrier frequency, including a carrier frequency generator for generating different carrier frequencies, the carrier frequency generator having at least one capacitor and a detunable oscillator crystal detuned through the at least one capacitor, and a transmitter modulating data messages with the carrier frequencies and transmitting the data messages in temporal succession.

A very simple and low-cost option for implementing the different carrier frequencies entails the connection of at least one capacitor, preferably, a plurality of capacitors, with different capacitances and/or in different interconnections, to an oscillator crystal of the carrier frequency generator, which is detuned in a specific manner by the capacitor(s).

In accordance with an added mode of the invention, the at least one capacitor is a plurality of capacitors and a switch respectively connects at least one of the plurality of capacitors to the oscillator crystal to generate different carrier frequencies.

In accordance with an additional feature of the invention, the switch is a program-controlled switch.

In accordance with yet another feature of the invention, there is provided a carrier frequency control device for setting different carrier frequencies in a case of multiple transmission, the control device connected to at least one of the group consisting of the plurality of capacitors and the switch.

With the objects of the invention in view, there is also provided a device for carrying out simplex transmission of a data message modulated onto a carrier frequency, including a carrier frequency generator for generating different carrier frequencies, the carrier frequency generator having at least one capacitor and a detunable oscillator crystal detuned through the at least one capacitor, and a transmitter modulating data messages with the carrier frequencies and transmitting the data messages more than one time using at least two different carrier frequencies in temporal succession to increase immunity to interference; the carrier frequencies only changed to have the carrier frequencies occur within one single transmission channel.

Other features that are considered as characteristic for the invention are set forth in the appended claims.

Although the invention is illustrated and described herein as embodied in a method and device for carrying out simplex data transmission, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block and schematic circuit diagram of a device for carrying out the method according to the invention;

FIG. 2 is a graph of a specific transmission function of a DSSS transmission according to the invention; and

FIGS. 3 to 6 are each graphs illustrating simulation results showing the increase in transmission quality of the application of the method according to the invention.

### DESCRIPTION OF THE PREFERRED EMBODIMENTS

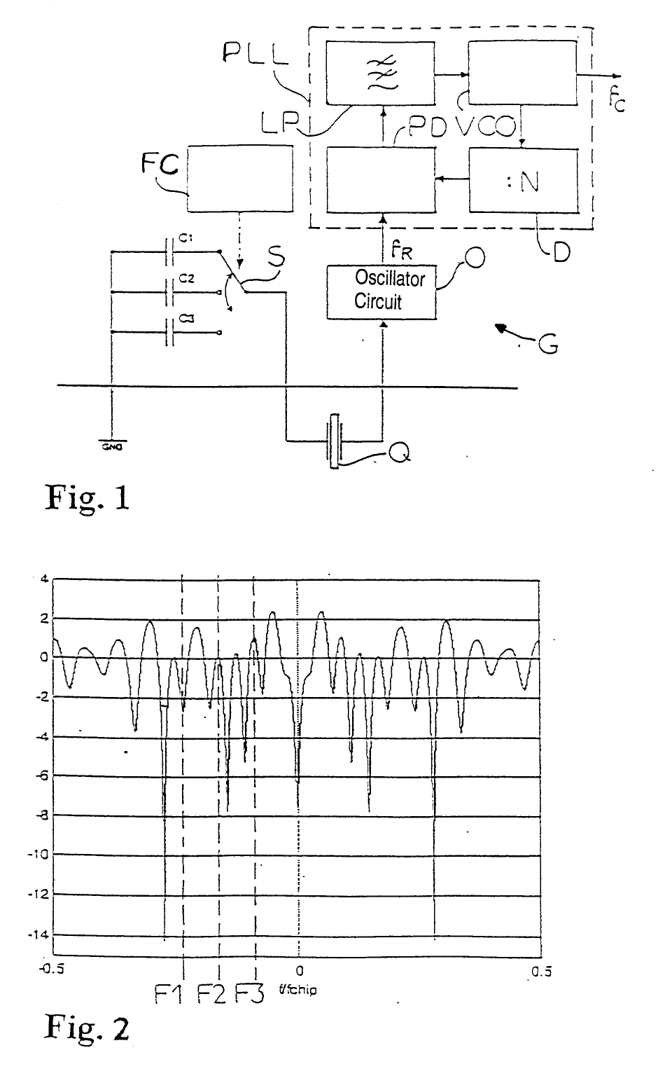

Referring now to the figures of the drawings in detail and first, particularly to FIG. 1 thereof, there is shown a basic diagram illustrating a simple configuration of a detunable carrier frequency generator G. In the generator G, a conventional oscillator crystal Q is optionally connected through one of three capacitors C1, C2, C3 with different capacitances to ground (GND) and the oscillation frequency of the oscillator circuit 0 is influenced by the respective connected capacitor. The oscillator circuit 0 supplies a reference frequency f_{R} for a PLL circuit PLL, which—in a conventional manner—has a phase discriminator PD, a low-pass filter LP, a voltage-controlled oscillator VCO and an :N-divider D in the conventional circuit, and at whose output the carrier frequency f_{C} is provided as an N-fold of the reference frequency f_{R}. The capacitors C1, C2, C3 are connected by a carrier frequency control unit FC in accordance with a predefined routine (for example, stored in an internal program memory of the frequency control unit). The capacitances of the capacitors are selected so that the (otherwise conventionally constructed) oscillator O is detuned such that the resulting change in the carrier frequency lies in the order of magnitude of the data rate. The time characteristic of the carrier frequency variation is limited, on one hand, by the scope of the data message and the transmission rate and, on the other hand, by the required response time of the system, so that several tens of milliseconds are typically required for each transmission procedure (according to the current state of knowledge) and a number of between two and around ten transmissions are possible.

FIG. 2 shows a transmission function of a spread sequence used for DSSS transmission according to a further development of the method according to the invention. The f/fchip ratio is plotted on the X-axis and the transmission gain is plotted on the Y-axis. As already mentioned above, the transmission function shows that the method of the invention, in conjunction with the use of DS spread spectrum technology, for statistical reasons produces a gain in transmission quality. Specifically, three randomly selected carrier frequencies F1, F2 and F3 are included in the graphical representation. Gain values of around −2 dB, 0 and +1 dB correspond to these frequencies. Thus, for any given output carrier frequency (here, for example, F2), there exists a probability, which increases with the number of variation steps, of achieving a more favorable signal-to-noise ratio than at the outset, with at least one variation step in relation to a narrowband interference source.

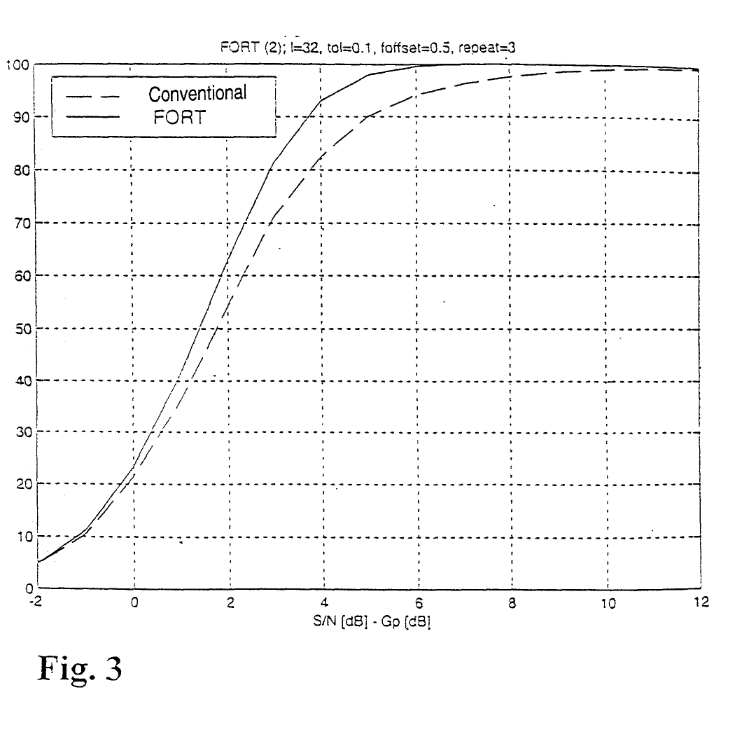

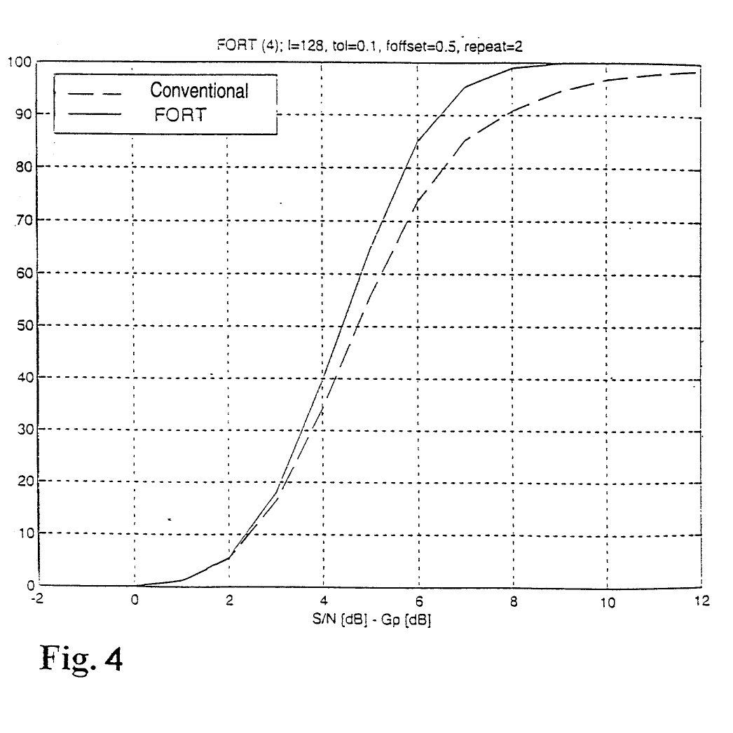

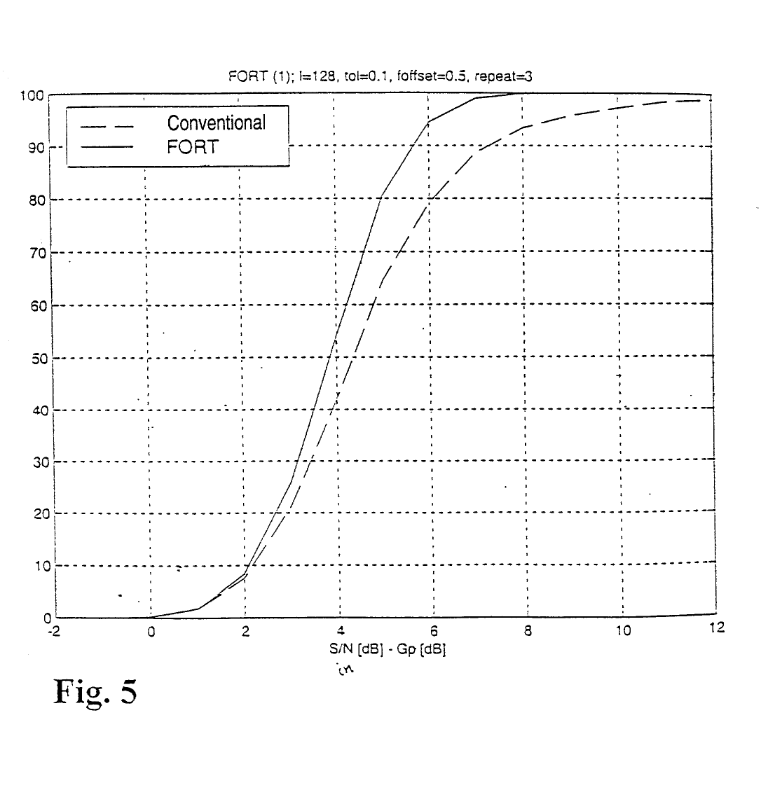

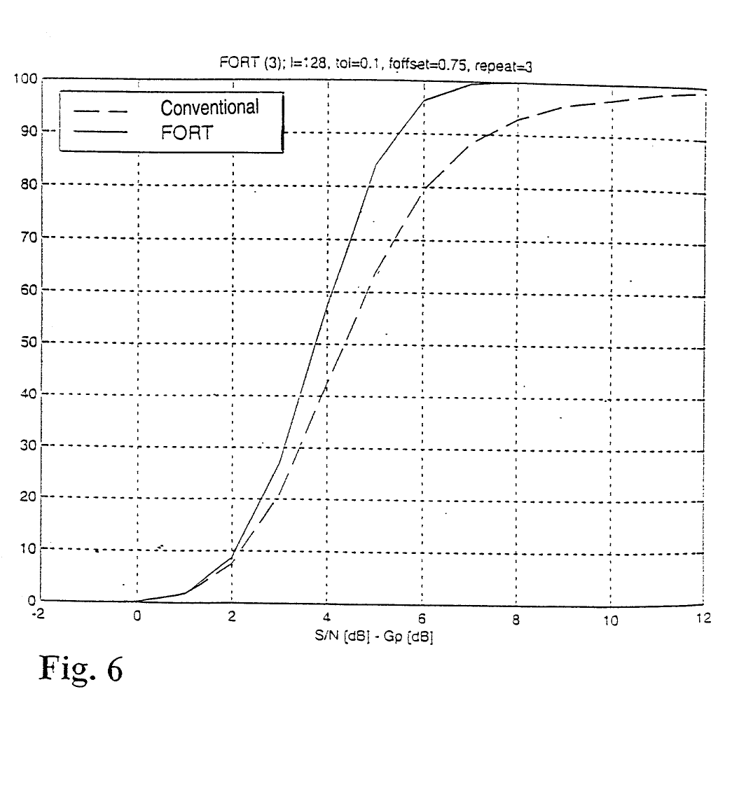

FIGS. 3 to 6 illustrate contrasting simulation results to compare a conventional data message transmission on a constant carrier frequency with a transmission using a varied carrier frequency (“FORT”). The difference between the initial signal-to-noise ratio S/N and the process gain Gp achieved through the use of spread spectrum technology (with a spread factor 31 around 15 dB) is plotted on the X-axis and the probability of a successful transmission is plotted as a percentage on the Y-axis.

The following assumptions have been made in determining the results:

A very narrowband, random-frequency interference is present.

The synchronization has no effect on performance.

The initial S/N ratio (S/N) is modified by the value of the spread sequence transmission function at the interference frequency (mapped onto the baseband). As a result, for the simulation, any given transmission function value was selected for each pass.

The bit error rate is derived from the bit error curve for PSK (Phase Shift keying) through the AWGN channel.

The change in the carrier frequency in the case of FORT is subject to certain randomness due to tolerances of the components.

A transmission attempt is deemed to be successful if at least one message contained no bit error.

The following FORT transmission parameters were selected or varied:

Message length “I” (number of bits): 128 and 32;

Frequency change “foffset”, related to data rate (data rate=1/31*chip frequency fchip): 0.5*data rate and 0.75*data rate;

Tolerance of the frequency change “tol”: 10% (→e.g. foffset=0.45 . . . 0.55*data rate); and

Number of the telegram repetition “repeat”: 2 and 3.

It is evident that, particularly in the high reliability range (successful transmission attempts >95%), use of the FORT method brings advantages. Here, the gain in the initial S/N ratio is 2 dB and more.

Implementation of the invention is not restricted to the examples illustrated above, but is also possible in a multiplicity of variations. Thus, in particular, further options exist for controlled variation of the carrier frequency and further options for combination of the proposed method with spread spectrum technologies and advanced modulation and coding methods. Essentially, the method can also be advantageously used in duplex data transmissions.

We claim:

1. A method for carrying out simplex transmission of a data message modulated onto a carrier frequency, which comprises:
transmitting a data message more than one time using at least two different carrier frequencies in temporal succession to increase immunity to interference; and
only changing the carrier frequencies such that the frequencies occur within one single transmission channel.

2. The method according to claim 1, which further comprises using a different carrier frequency for each of more than two transmissions.

3. The method according to claim 1, which further comprises applying spreading to the data message by a predefined spread sequence.

4. The method according to claim 3, wherein the at least two different carrier frequencies have a frequency difference in an order of magnitude of a data rate of the data message

5. The method according to claim 3, wherein the at least two different carrier frequencies have a frequency difference in a range between one quarter and two times a data rate of the data message.

6. The method according to claim 1, which further comprises applying spreading to the data message by a Direct Sequence Spread Spectrum method.

7. The method according to claim 6, wherein the at least two different carrier frequencies have a frequency difference in an order of magnitude of a data rate of the data message

8. The method according to claim 6, wherein the at least two different carrier frequencies have a frequency difference in a range between one quarter and two times a data rate of the data message.

9. The method according to claim 1, which further comprises setting the at least two different carrier frequencies within a tolerance range of at least ±10%.

10. The method according to claim 1, which further comprises setting the at least two different carrier frequencies within a tolerance range of not more than ±10%.

11. A method for simplex radio transmission in a radio access control system, which comprises:
transmitting a data message more than one time using at least two different carrier frequencies in temporal succession to increase immunity to interference; and
only changing the carrier frequencies such that the frequencies occur within one single transmission channel.

12. A device for carrying out simplex transmission of a data message modulated onto a carrier frequency, comprising:
a carrier frequency generator for generating different carrier frequencies, said carrier frequency generator having at least one capacitor and a detunable oscillator crystal detuned through said at least one capacitor; and
a transmitter modulating data messages with said carrier frequencies and transmitting the data messages in temporal succession.

13. The device according to claim 12, wherein:
said at least one capacitor is a plurality of capacitors; and
a switch respectively connects at least one of said plurality of capacitors to said oscillator crystal to generate different carrier frequencies.

14. The device according to claim 13, wherein said switch is a program-controlled switch.

15. The device according to claim 13, including a carrier frequency control device for setting different carrier frequencies in a case of multiple transmission, said control device connected to at least one of the group consisting of said plurality of capacitors and said switch.

16. A device for carrying out simplex transmission of a data message modulated onto a carrier frequency, comprising:
a carrier frequency generator for generating different carrier frequencies, said carrier frequency generator having at least one capacitor and a detunable oscillator crystal detuned through said at least one capacitor; and
a transmitter modulating data messages with said carrier frequencies and transmitting the data messages more than one time using at least two different carrier frequencies in temporal succession to increase immunity to interference; said carrier frequencies only changed to have said carrier frequencies occur within one single transmission channel.

17. The device according to claim 16, wherein:
said at least one capacitor is a plurality of capacitors; and
a switch respectively connects at least one of said plurality of capacitors to said oscillator crystal to generate different carrier frequencies.

18. The device according to claim 17, wherein said switch is a program-controlled switch.

19. The device according to claim 17, including a carrier frequency control device for setting different carrier frequencies in a case of multiple transmission, said control device connected to at least one of the group consisting of said plurality of capacitors and said switch.
